(19) United States
(12) Patent Application Publication
(10) Pub. No.: US 2011/0299805 A1
(43) Pub. Date: Dec. 8, 2011

(54) Prong Cage for an Angular Contact Ball Bearing and Method for Assembling an Angular Contact Ball Bearing

(75) Inventors: Frank J. Damato, Keene, NH (US); James M. Sanville, Troy, NH (US)

(73) Assignee: THE TIMKEN COMPANY, Canton, OH (US)

(21) Appl. No.: 13/201,732

(22) PCT Filed: Feb. 16, 2010
(86) PCT No.: PCT/US2010/024251

§ 371 Date: Aug. 16, 2011

Related U.S. Application Data
(60) Provisional application No. 61/152,829, filed on Feb. 16, 2009.

(51) Int. Cl. F16C 33/38; B23P 11/00

(52) U.S. Cl. 384/531; 29/898.061

(57) ABSTRACT

An angular contact ball bearing cylindrical retainer element (100) with a reduced mass, reduced axial width, and a rigid “crown” shape. The rigid crown shape of the cylindrical retainer element (100) defines a plurality of uniformly spaced cylindrical ball receiving pockets (104) about the circumference of the cylindrical retainer (100), each receiving pocket partially open to a slot (108) on an axial end of the retainer (100) and enclosed at an opposite axial end to define a continuous axial side rail (110).

### CROSS-REFERENCE TO RELATED APPLICATIONS

The present application is related to, and claims priority from, U.S. Provisional Patent Application Ser. No. 61/152,829 filed on Feb. 16, 2009, and which is herein incorporated by reference.

### STATEMENT REGARDING FEDERALLY SPONSORED RESEARCH

Not Applicable.

### BACKGROUND OF THE INVENTION

The present disclosure is related generally to small angular contact ball bearings, and in particular, to a small angular contact ball bearing for use in an application having only a limited axial space for a ball retainer.

Within an angular contact ball bearing assembly, a traditional angular contact ball bearing (ACBB) retainer, such as shown in FIG. 1, is an annular structure which protrudes past both sides of, or completely surrounds, the ball elements which are disposed within openings about the circumference of the structure. An alternative configuration, known as a crown retainer, is shown in FIGS. 2 and 3, and protrudes past only one side of each ball elements which are contained within the open-sided pockets, but because the crown retainer must snap-fit over each ball element, it permits a larger axial movement in one direction than the other. Both traditional angular contact ball bearing (ACBB) retainers and crown-type retainers require a minimum amount of axial distance to operate correctly. For some bearing applications, this required minimum axial distance may be greater than the available axial distance inside the bearing, particularly when considering requirements of closures, clearances, room for lubricant, etc. In some cases, a wider bearing can be used in the final application. In other cases, a narrower bearing must be used. When a narrower bearing is required, with the traditional type ACBB retainers and crown-type retainers, sometimes there is insufficient room for all the desired components.

Some angular contact ball bearing applications require a lower mass retainer, for either retainer dynamic issues, or to help reduce the overall mass of the bearing assembly. A traditional ACBB retainer has more mass than a crown-type retainer, since a traditional crown-type retainer typically is designed for a deep groove ball bearing, and has fewer balls than an angular contact ball bearing. Fewer balls in a ball bearing means the bearing typically has a reduced load capability.

Traditional crown-type retainers are either of the “ball piloting” design or the “ring piloting” design. With the “ball piloting” design, the crown retainer is less tolerant of misalignment and very high speeds, and the piloting dimensions can reduce the introduction of lubricant to the ball/retainer interface. In contrast, with the “ring piloting” design, the crown-type retainer is more tolerant of higher speeds and misalignment, but the design has more ball pocket clearance, and the axial movement of the retainer caused by the loose pocket clearances required may result in problems.

Some larger angular contact ball bearings require one or two axial end closures to help to keep contaminants out of the bearing, and/or to keep particles generated by the bearing inside the bearing. For very small angular contact ball bearings such as those used in medical and dental devices, the inclusion of a second closure can be beneficial to bearing life, however, due to width requirements of the final bearing, traditional angular contact ball bearing retainers cannot be fitted into the available space envelope. While traditional angular contact retainers can be manufactured with one regular width rail and one very narrow rail to fit into smaller space envelopes, due to the extremely small size of some medical bearings, a traditional angular contact retainer with one regular width rail and one very narrow rail is not practical to manufacture. Furthermore, the narrow rail can cause manufacturing problems that make the design impractical and can be a source of later retainer fractures or failures.

Accordingly, it would be advantageous to provide a ball bearing retainer which is suitable for use in angular contact ball bearings, such as those used in medical and dental devices, and which has high tolerances to correctly limit movement during bearing operation, a reduced axial width for use in those bearings that require space within which to fit one or more closures (typically a shield or seal), and which can be used in those bearings that require a retainer with reduced mass.

### BRIEF SUMMARY OF THE INVENTION

Briefly stated, the present disclosure provides an angular contact ball bearing retainer with reduced axial width and a “crown” shape. However, in contrast to standard “crown” type snap-in retainers, the present invention retainer does not provide a snap fit about the ball elements. Rather, the retainer of the present invention is installed onto the inner or outer ring along with the balls, and then the other ring is assembled, typically using thermal heating and/or cooling of the bearing rings. The lack of snap fitment on the retainer limits axial movement or clearance of the retainer, so as to correctly limit its movement during bearing operation. The present invention crown style retainer further has a reduced axial width for use in bearings requiring more room to fit one or more axial closures (typically a shield or seal), and may be used in those bearings that require a retainer with reduced mass.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective view of a prior art angular contact ball bearing retainer;

FIG. 2 is a perspective view of a prior art stamped metal crown ball bearing retainer;

FIG. 3 is a perspective view of a prior art machined or molded “snap-in” style of crown ball bearing retainer;

FIG. 4 is a sectional view of a crown-type ball bearing retainer of the present disclosure;

FIG. 5 is a top plan view of a section of the crown-type ball bearing retainer of FIG. 4;

FIG. 6 is a sectional view of a bearing assembly incorporating the crown-type bal bearing retainer of FIG. 4; and

FIGS. 7A-7C illustrate a limited range of movement for ball elements secured within the bearing retainer of the present disclosure.

FIGS. 8A-8T illustrates exemplary retainer cross sections for the crown type ball bearing retainer of FIG. 4.

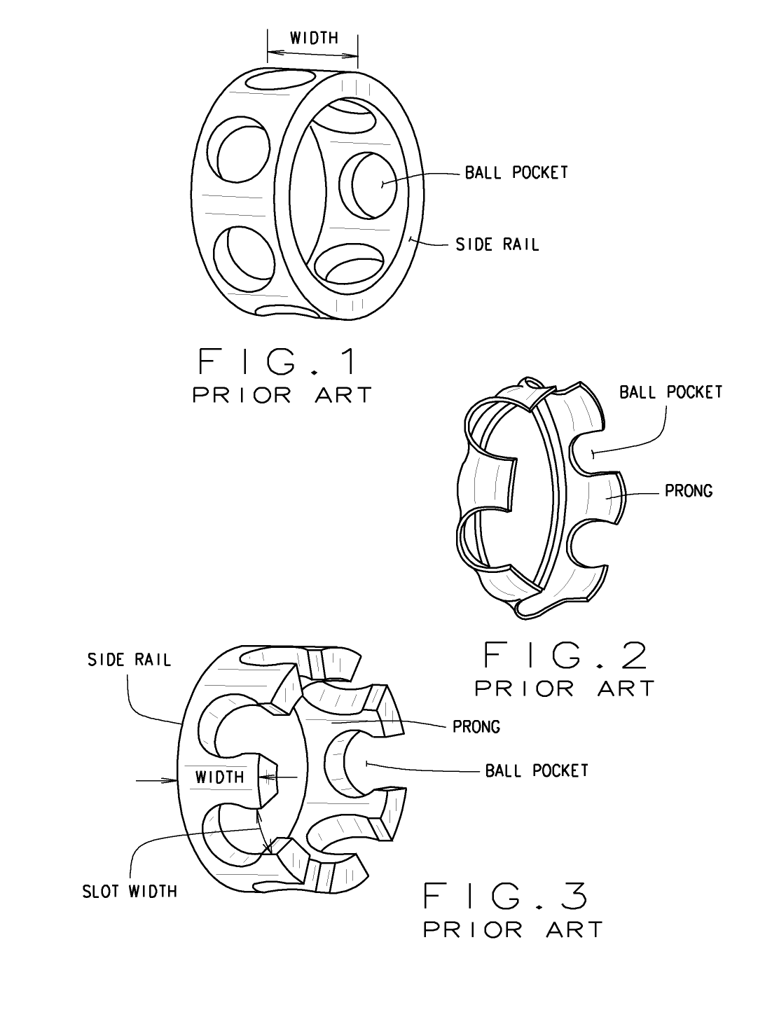

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

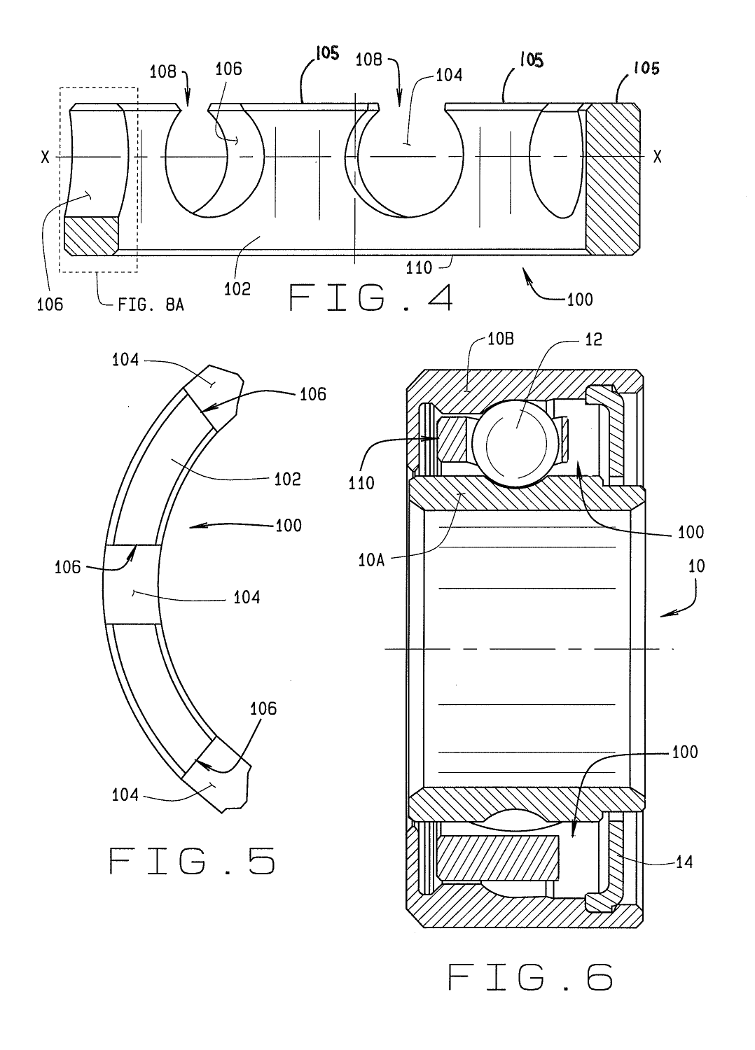

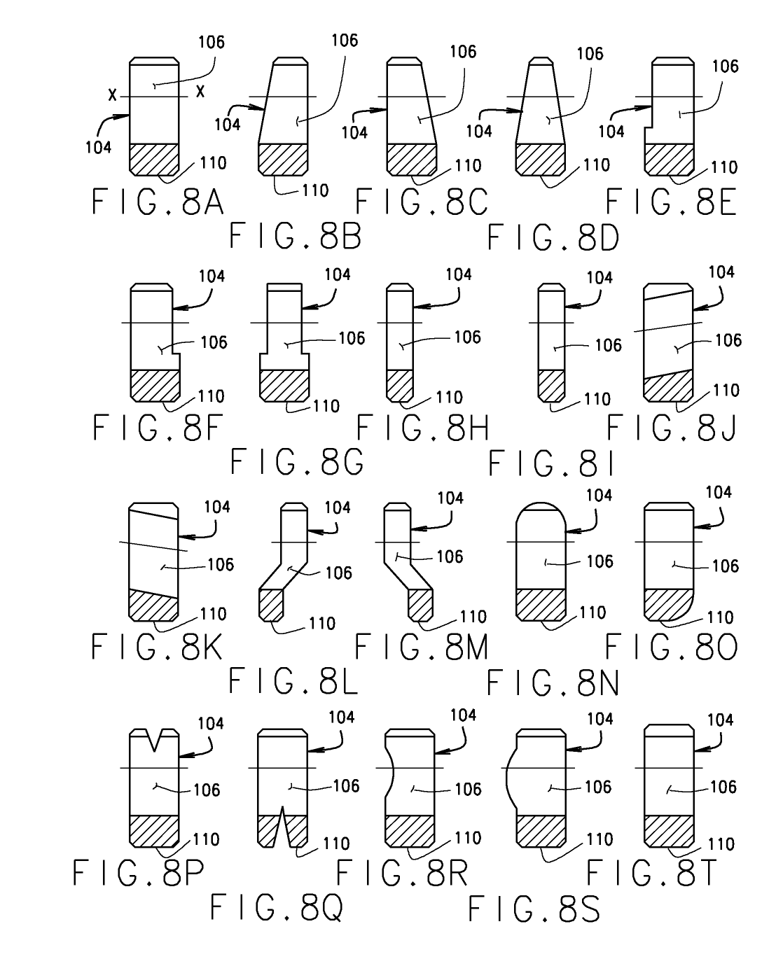

Turning to the Figures, and to FIGS. 4-6 in particular, an improved angular contact ball bearing retainer 100 of the present disclosure is shown to be different than both the traditional angular contact ball bearing (ACBB) retainers and the traditional stamped, machined, or molded crown-type and snap-in retainers. The preferred embodiment of the present disclosure is a cylindrical retainer body 102, with cylindrical ball pockets 104 arrayed around the circumference of the retainer body 102 as shown in FIG. 5. The axis X of each cylindrical ball pocket 104 intersects an axial centerline of the retainer body. As best seen in FIG. 4, the sidewall 106 of each ball pocket 104 is open on one axial end of the retainer, defining a slot 108. Remaining portions of the retainer body 102 disposed between each slot 108 define a set of prongs 105, similar to a “crown” configuration. Axially opposite from the slots 108, the structure of the retainer body 102 defines a single continuous side rail 110. Those of ordinary skill in the art will recognize that while the retainer body 102 is shown to have a cylindrical configuration with a rectangular cross-section, as best seen in FIG. 8A, the cross-sectional configuration, including the orientation of the cylindrical ball pockets 104, may be varied to accommodate the particular bearing assembly 10 into which the retainer 100 is to be utilized, as is shown by the exemplary cross-sectional configurations of FIGS. 8B-8T.

Preferably, the retainer 100 is machined from metallic or polymer stock, but those of ordinary skill will recognize that the retainer may be manufactured from a molded polymer or metallic material. The retainer 100 is manufactured with precision manufacturing practices, including broken/blended/deburred surface intersections to promote correct piloting of the retainer 100 on the bearing inner and outer rings (10A, 10B) and balls 12. In basic appearance, the retainer 100 of the present disclosure appears similar to a traditional crown retainer, but it is different in a number of ways, as shown below.

First, the retainer 100 of the present disclosure is a non-snap design, i.e., the retainer 100 cannot be assembled into a ball bearing 10 after the inner ring 10A, outer ring 10B, and ball elements 12 are assembled and correctly spaced. Rather, the retainer 100 is installed onto the inner ring 10A or outer ring 10B along with the balls 12, prior to the assembly of the remaining ring (10B or 10A), which is typically done using thermal heating and/or cooling of the bearing rings (10A, 10B). The bearing assembly (10) may then be provided with optional closures (14) at one or both axial ends.

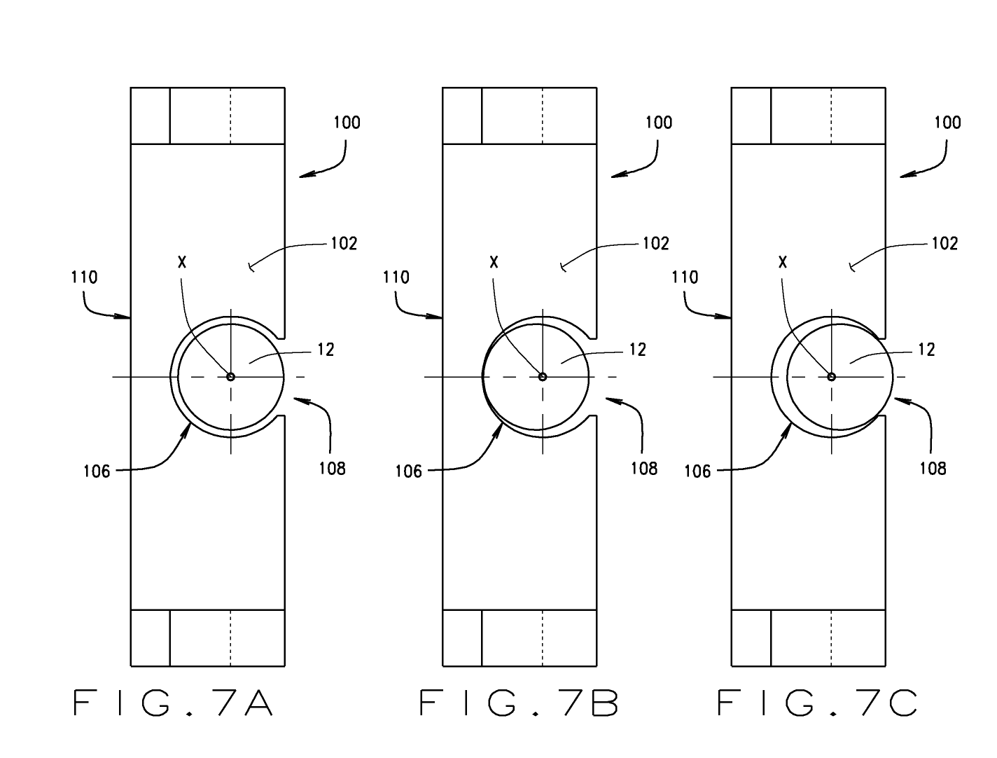

Second, the retainer 100 of the present disclosure is preferably configured to have a smaller range of axial movement than a traditional crown-type snap-in retainer, because the retainer 100 can envelope more of the circumference of each ball element 12, as best seen in FIGS. 7A-7C. A traditional crown-type snap-in retainer must have a relatively large slot width, so that the prongs of the retainer can elastically deform enough to slip past the larger ball diameters during assembly and then return to their original design shape for use, to retain the retainer inside the bearing. Large axial movement requires more room inside the bearing 10, which reduces available room for additional closures or a volume of lubricant. While some traditional crown-type snap-in retainers have very low axial movement due to very flexible prongs and very small ball pocket clearance, they also tend to be “ball piloting” designs, which are less favorable for high speed and/or high misalignment operation.

The improved retainer 100 of the present disclosure is axially and radially narrower, creating more room inside the bearing 10 for closures or lubricant.

The improved retainer 100 of the present disclosure is lighter than a traditional ACBB retainer, and so contributes less mass to the total mass of the bearing 10.

The improved retainer 100 of the present disclosure has increased compliance, because of the presence of the slots 108 axially opposite from the single side rail 110, which alters the retainer dynamics, affecting correct bearing operation and/or noise generation of the bearing assembly 10.

The improved retainer 100 of the present disclosure is more open on one axial side due to the presence of the slots 108 (i.e., the ball elements 12 are more exposed), so the introduction of lubricant to the balls elements 12 during a lubrication process is easier.

The cylindrical sidewalls 106 of the ball pockets 104 in the retainer 100 allow the retainer 100 to be piloted primarily on the lands of one of the bearing rings (10A or 10B), and secondarily on the ball component 12, so that the retainer 100 is suitable for high speed bearing operation with minimum friction and wear. Because the ball elements 12 are not retained in the retainer 100 when the retainer is not installed in a bearing, the ball pocket 104 and ring land clearances can be optimized for high speed or alternately for lower speed operation.

The improved retainer 100 of the present disclosure, although it is of the “crown type”, can be manufactured with a greater number of ball pockets 104 than a traditional snap-in style retainer of the same diameter, because the retainer 100 is assembled into an angular contact ball bearing 10 using typical angular contact ball bearing assembly methods, and without the need to permit resilient flexing or movement required by a traditional snap-in crown-type retainer to fit over the ball elements 12. The improved retainer 100 can be manufactured with the same number of ball pockets 104 as a traditional angular contact ball bearing (ACBB) retainer.

As various changes could be made in the above constructions without departing from the scope of the disclosure, it is intended that all matter contained in the above description or shown in the accompanying drawings shall be interpreted as illustrative and not in a limiting sense.

1. An improved angular contact ball bearing retainer (100) configured for use in a bearing assembly (10) having an inner ring (10A), an outer ring (10B), and a plurality of ball elements (12) disposed there between, comprising:
a cylindrical retainer body (102);
a plurality of radially directed cylindrical ball pockets (104) arrayed around the circumference of the retainer body (102), an axis (X) of each cylindrical ball pocket (104) intersecting an axial centerline of the retainer body (102);
wherein a sidewall (106) of each cylindrical ball pocket (104) includes a slot (108) which opens to one axial end of the retainer (100);
wherein an outer surface of each of said ball elements (12) is fully disposed within a ball pocket (104) in an axial direction, parallel to said retainer body centerline (102); and
wherein said sidewall (106) of each cylindrical ball pocket (104) is sufficiently rigid to prevent passage of said ball element (12) through said slot (108).

2. The improved angular contact ball bearing retainer (100) of claim 1 wherein each of said slots (108) in said cylindrical ball pocket sidewalls (106) has a width which is less than a diameter of a ball element (12) disposed within said cylindrical ball pocket (104); and
wherein said cylindrical retainer body (102), together with said cylindrical ball pockets (104) and said ball pocket sidewall slots (108), defines a crown configuration having rigid prongs (105) disposed between each of said sidewall slots (108).

3. The improved angular contact ball bearing retainer (100) of claim 1 wherein said cylindrical retainer body (102) includes only one continuous axial side rail (110), axially opposite from said slots (108) in said ball pocket sidewalls (106).

4. The improved angular contact ball bearing retainer (100) of claim 1 wherein said cylindrical ball pockets (104) are configured to enable the cylindrical retainer body (102) to pilot primarily on a ring land of either the inner ring (10A) or the outer ring (10B) of the bearing assembly (10), and secondarily on the ball elements (12), such that said retainer (100) is adapted for bearing operating with minimum friction and wear.

5. (canceled)

6. (canceled)

7. The improved angular contact bearing retainer (100) of claim 1 wherein said cylindrical retainer body (102) is machine formed.

8. The improved angular contact bearing retainer of claim 1 wherein said cylindrical retainer body (102) is mold formed.

9. A method for assembling an angular contact ball bearing assembly (10) having a plurality of ball elements (12) positioned within ball pockets (104) of a bearing retainer (100) having slots (108) opening from a common axial surface into each of said ball pockets (104), and disposed between an inner ring (10A) and an outer ring (10B), comprising:
installing the bearing retainer (100) onto a first of said inner and outer rings (10A, 10B) together with the plurality of ball elements (12), each of said ball elements (12) disposed fully within a ball pocket (104) of said bearing retainer (100) in an axial direction; and
assembling the second of said inner and outer rings (10A, 10B) to radially retain said bearing retainer (100) and said plurality of ball elements (12) between said inner and outer rings (10A, 10B).

10. The method of claim 9 further including the step of installing at least one closure (14) at an axial end of the angular contact ball bearing (10).

11. The method of claim 9 further wherein said bearing retainer (100) is primarily piloted on a land of at least one of said inner and outer rings (10A, 10B) and secondarily on said ball elements (12).

12. (canceled)

13. (canceled)

14. The improved angular contact bearing retainer of claim 1 wherein said axis (X) of each cylindrical ball pocket (104) intersects said axial centerline of the retainer body (102) at an oblique angle.

15. The improved angular contact bearing retainer of claim 1 wherein said cylindrical retainer body (102) has an axially asymmetric radial cross-section.
